(19) United States
(12) Patent Application Publication
(10) Pub. No.: US 2006/0212896 A1
(43) Pub. Date: Sep. 21, 2006

(54) Content distribution systems and methods

(75) Inventor: Chih-Yen Lin, Changhua County (TW)

Correspondence Address: BIRCH STEWART KOLASCH & BIRCH, PO BOX 747, FALLS CHURCH, VA, 22040-0747, US

(73) Assignee: ULEAD SYSTEMS, INC.

(21) Appl. No.: 11/084,244

(22) Filed: Mar. 21, 2005

(51) Int. Cl. H04N 7/10; H04N 7/025

(52) U.S. Cl. 725/32

(57) ABSTRACT

Content distribution systems and methods. A content source comprises a service advertising channel and a content delivery channel. The content source provides service information on the service advertising channel, and provides content on the content delivery channel. At least one content sink couples to the content source to acquire the service information from the service advertising channel, and specify a content item from the content for playback according to the service information. The content sink further controls the content source via a control channel between the content source and the content sink.

### BACKGROUND

The present disclosure relates generally to content distribution systems and methods, and more particularly, to systems and methods for providing content over a home network.

Currently, distribution of digital home content is an on-demand service. For example, a content sink first connects to a content source using a specific technique, such as UPnP (Universal Plug and Play), and acquires a content directory. The content sink then chooses a specific content item for playback accordingly.

Broadcast services, such as music and video jukeboxes, DVB (Digital Video Broadcast)/TV/Cable typically distribute content over a home network. Since the content sink must browse and search entry points in the content directory for specific broadcast services, and be set accordingly to initialize a specific service, on-demand behavior is inconvenient.

### SUMMARY

Content distribution systems and methods are provided. An exemplary embodiment of a content distribution system comprises at least one content source and at least one content sink. The content source comprises a service advertising channel and a content delivery channel. The content source provides service information on the service advertising channel, and provides content on the content delivery channel. The content sink is coupled to the content source to acquire the service information from the service advertising channel, and specify specific a content item from the content for playback according to the service information.

In an exemplary embodiment of a content distribution method for use in a content source comprising a service advertising channel and a content delivery channel, and at least one content sink, service information is provided on the service advertising channel, and content is provided on the content delivery channel by the content source. The service information is acquired from the service advertising channel by the content sink. A content sink specifies a specific content item from the content and play backs the content according to the service information.

Content distribution systems and methods may take the form of program code embodied in a tangible media. When the program code is loaded into and executed by a machine, the machine becomes an apparatus for practicing the disclosed method.

### DESCRIPTION OF THE DRAWINGS

The invention will become more fully understood by referring to the following detailed description with reference to the accompanying drawings, wherein:

FIG. 1 is a schematic diagram illustrating an embodiment of a content distribution system;

FIG. 2 is a flowchart showing an embodiment of a content distribution method on a content source;

FIG. 3 is a flowchart showing an embodiment of processing a multimedia broadcasting service on the content source;

FIG. 4 is a flowchart-showing an embodiment of a content acquisition method on a content sink;

FIG. 5 is a flowchart showing an embodiment of checking input on the content sink; and

FIG. 6 is an example showing a multimedia broadcasting service over a home network.

### DESCRIPTION

Content distribution systems and methods are provided.

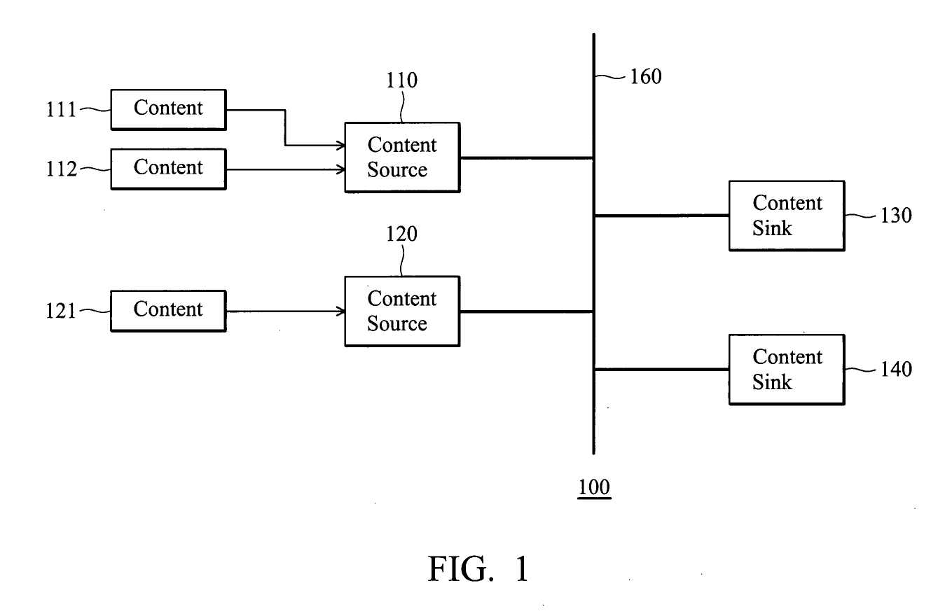

FIG. 1 is a schematic diagram illustrating an embodiment of a content distribution system.

The content distribution system 100 comprises at least one content source and at least one content sink. The content distribution system 100 may be a multimedia broadcasting system. In FIG. 1, the system 100 includes two content sources (110 and 120) and two content sinks (130 and 140). Two content items (111 and 112) are on the content source 110, and content item 121 is on the content source 120. Content items on the content sources are broadcasted to the content sinks (130 and 140) over a home network 160. The content may be provided by various devices or applications, such as DVB/TV/Cable receiver devices, video capture cards, web cameras, jukebox-like applications, and DV camcorders.

The content source provides a multimedia broadcasting service to the content sinks. The multimedia broadcasting service includes content delivery, service advertisement, and back service control mechanisms. The service uses multicasting to transmit multimedia content to the content sinks. The content source does not need to know the location of the content sinks, and the content sink does not need to know the location of the content source. The content sink can receive and playback content transmitted from the content source.

System comprises three kinds of channels, a service advertising channel, a content delivery channel, and a back service control channel (not shown). The service advertising channel is a default IP multicast group for advertising the multimedia broadcasting service. The content source can periodically provide multimedia broadcasting service information regarding content thereon to the service advertising channel, informing any interested devices comprising content sources and content sinks. The content source can acquire other content source information (multimedia broadcasting service information) from the service advertising channel. The content sink can also acquire the multimedia broadcasting service information of all content sources via an IP multicast mechanism. The service information comprises information for the content source, current broadcasting content, metadata, formats, and IDs thereof, and control channels of respective content. The content delivery channel is an IP multicast group which is chosen by the content source for content delivery. The content source can mix different content items into the content delivery channel, and the content sink can filter and specify a specific content item using the service information. The back service control channel is a connection between the content source and the content sink for controlling a device/instance providing content on the content source. It is understood that different devices/instances may have different control schemes, and the corresponding control protocols will be specified in the service advertisement.

It is understood that the content sink can be a dummy playback device, receiving and playing back content from the content delivery channel. The content sink can also act as an active content sink to control the multimedia broadcasting service and corresponding device/instance via the back service control channel.

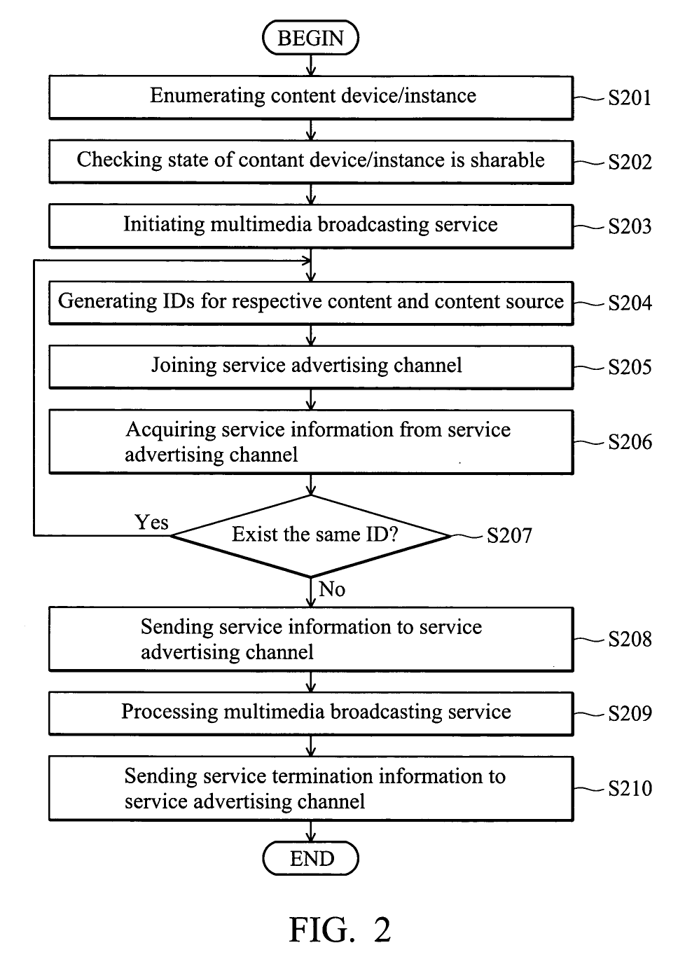

FIG. 2 is a flowchart showing an embodiment of a content distribution method on a content source.

In step S201, the content source enumerates the content devices/instances thereon, and in step S202, determines whether the state of respective content device/instance is sharable. In step S203, the multimedia broadcasting service is initiated, and all sharable content devices/instances are added into the service. In step S204, IDs are generated for identification of respective content items and content source(s). In step S205, the service advertising channel is joined using an IP multicast mechanism, and in step S206, the service information is acquired from the service advertising channel. In step S207, it is determined whether the respective ID exists. If so, the procedure returns to step S204 to generate another ID. If not, in step S208, the service information comprising information for the content source, current broadcasting content, metadata, formats, and IDs thereof, and control channels of respective content on the content source is provided to the service advertising channel. In step S209, the multimedia broadcasting service is processed.

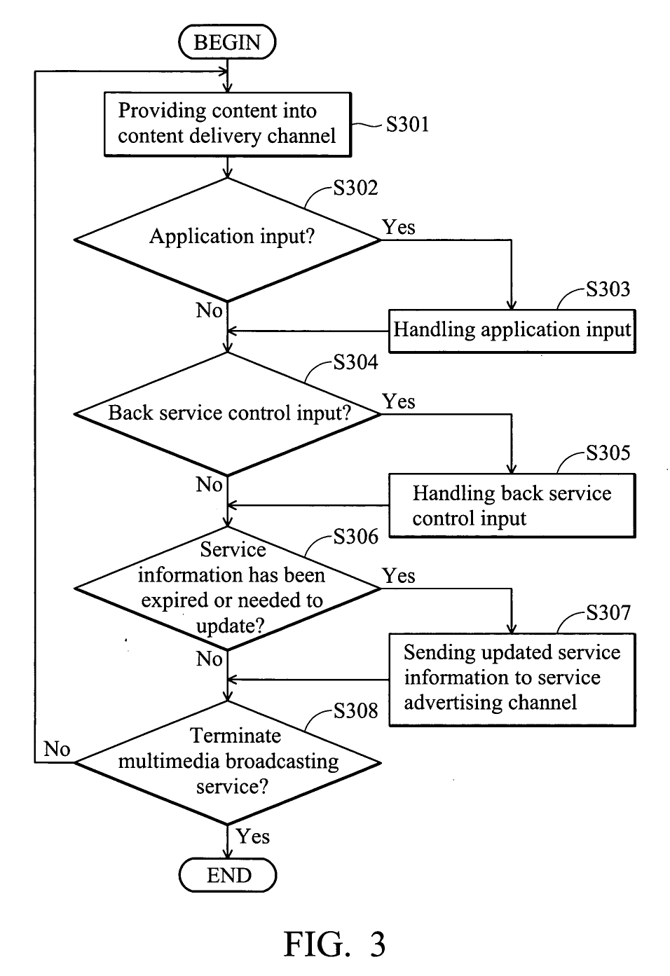

FIG. 3 is a flowchart showing an embodiment of processing multimedia broadcasting service on the content source. In step S301, content on the content source is provided (broadcast/multicast) to the content delivery channel. In step S302, it is determined whether any application input is received. The application input is from the content source. If so, in step S303, the application input is handled. If not, in step S304, it is determined whether any back service control input is received via the back service control channel. The back service control input is from the content sink. If so, in step S305, the back service control input is handled. If not, in step S306, it is determined whether the service information has expired or required updating. If so, in step S307, the service information is updated, and provided to the service advertising channel. Additionally, a new expiration time can be further set for the updated service information. It is understood that if the back service control input is to change a specific content item, the new content is provided to the content delivery channel, and the service information is updated regarding the change. In step S308, it is determined whether the multimedia broadcasting service has been or required to be terminated. Note that the termination of the multimedia broadcasting service can be controlled from the active content sink or the content source. If not, the procedure returns to step S301. If so, the procedure is complete. Referring to FIG. 2, in step S210, the service termination information is provided to the service advertising channel.

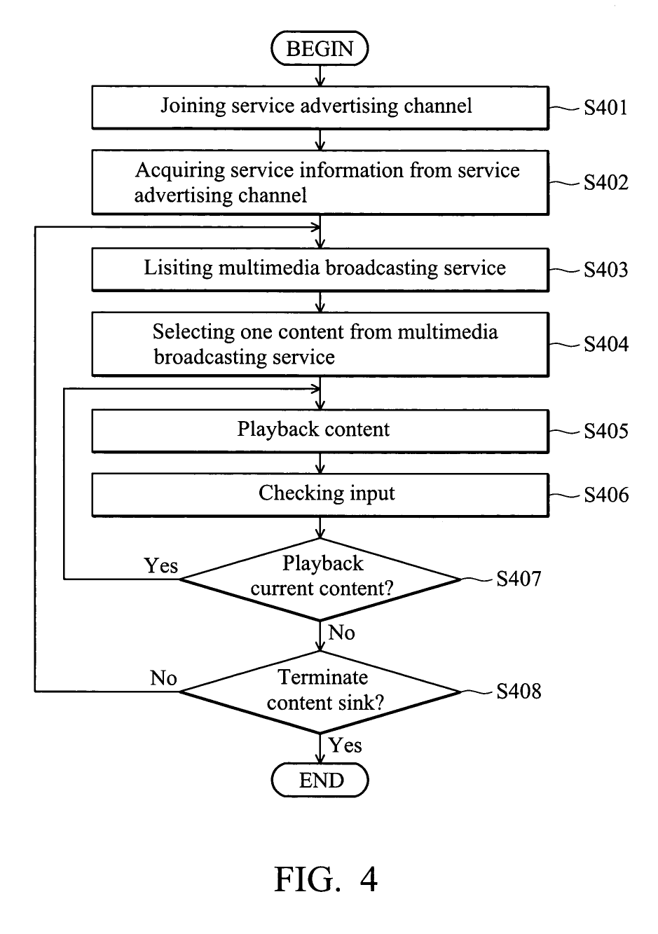

FIG. 4 is a flowchart showing an embodiment of a content acquisition method on a content sink.

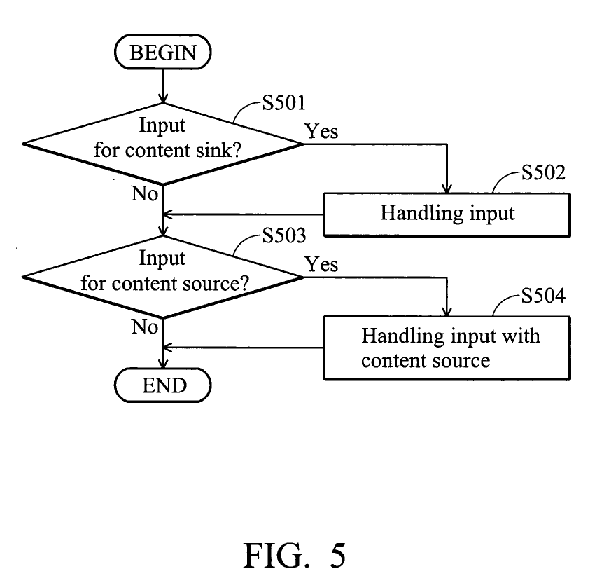

In step S401, the service advertising channel is joined using an IP multicast mechanism, and in step S402, the service information is acquired from the service advertising channel. In step S403, the content provided by the multimedia broadcasting service is listed. In step S404, a specific content item is selected from the multimedia broadcasting service for playback, and in step S405, the selected content is played back. It is understood that once the specific content item is selected, it can be specified from overall content using the service information, and the content sink is set for playback accordingly. In step S406, it is determined whether any input has been received. FIG. 5 is a flowchart showing an embodiment of checking input on the content sink. In step S501, it is determined whether any input for the content sink has been received. If so, in step S502, the input is handled. If not, in step S503, it is determined whether any input for content source is received. If so, in step S504, the input is handled with the content source via the back service control channel. If not, the procedure is complete. Referring to FIG. 4, in step S407, it is determined whether the current content is required to continuous playback. If so, the procedure returns to step S405. If not, in step S408, it is determined whether the content sink has been terminated. If not, the procedure returns to step S403. If so, the procedure is complete.

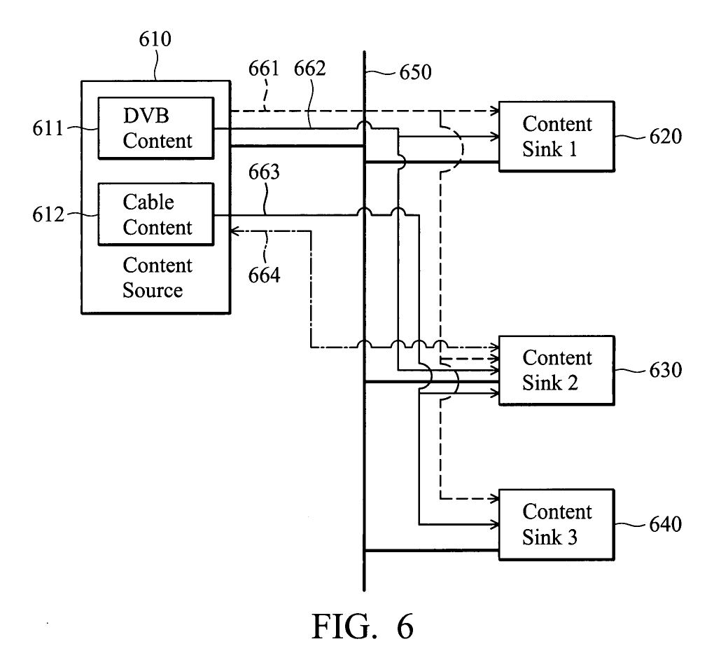

FIG. 6 is an example showing a multimedia broadcasting service over a home network. A content source 610 provides a multimedia broadcasting service to content sinks 620, 630 and 640 over a home network 650. Two content devices which provide DVB content 611 and cable content 612 are in the content source 610. The content source 610 uses IP multicast to provide service information for the DVB content 611 and cable content 612 on the service advertising channel 661. The content source 610 transmits the DVB content 611 and cable content 612 into separate IP multicast groups (content delivery channels 662 and 663). The content sink 1 and content sink 2 (620 and 630) can receive and playback the DVB content 611 from the content source 610, and the content sink 2 and content sink 3 (630 and 640) can receive and playback the cable content 612 from the content source 610. The content sink 2 (630) acts as an active content sink to control the content source 610 by sending request via back service control channel 664. Therefore, the content sink 2 (630) can use a control protocol specified in the service information to change the channel of the DVB device on the content source 610, and even turn the DVB device off. When the content sink 2 (630) changes the channel of the DVB device, the content sink 1 (620) will seamlessly receive and playback the new content. When the content sink 2 (630) turns off a cable device on the content source 610, the multimedia broadcasting service of the content source 610 will immediately advertise a new service information on the service advertising channel 661. The content sinks 2 and 3 (630 and 640) will then be informed by receiving up-to-date service information that the cable broadcasting service has been terminated. Thus, the content sinks 2 and 3 (630 and 640) can operate normally. For example, the content sink 2 (630) can stop playback the cable content 612, and the content sink 3 (640) can return to service selection.

Content distribution systems and methods, or certain aspects or portions thereof, may take the form of program code (i.e., executable instructions) embodied in tangible media, such as products, floppy diskettes, CD-ROMS, hard drives, or any other machine-readable storage medium, wherein, when the program code is loaded into and executed by a machine, such as a computer or a device comprising a mobile phone, the machine thereby becomes an apparatus for practicing the methods. The methods may also be embodied in the form of program code transmitted over some transmission medium, such as electrical wiring or cabling, through fiber optics, or via any other form of transmission, wherein, when the program code is received and loaded into and executed by a machine, such as a computer or a device comprising a mobile phone, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A content distribution system, comprising:
at least one content source comprising a service advertising channel and a content delivery channel, providing service information on the service advertising channel, and providing content on the content delivery channel; and
at least one content sink coupled to the content source, acquiring the service information from the service advertising channel, and specifying a content item from the content for playback according to the service information.

2. The system of claim 1 wherein the content sink further controls the content source via a control channel between the content source and the content sink.

3. The system of claim 1 wherein the content is mixed with a first content item and a second content item.

4. The system of claim 3 wherein the content sink further changes the first content item on the content source via a control channel between the content source and the content sink.

5. The system of claim 4 wherein the content source further provides the changed first content item on the content delivery channel.

6. The system of claim 5 wherein the content sink specifying the first content item receives and plays back the changed first content item.

7. The system of claim 3 wherein the content sink further terminates the first content item on the content source via a control channel between the content source and the content sink.

8. The system of claim 7 wherein the content source further provides updated service information with the termination of the first content item on the service advertising channel.

9. The system of claim 8 wherein the content sink specifying the first content item further stops playback of the first content item.

10. The system of claim 1 wherein the content source broadcasts the content to the at least one content sink via a home network.

11. The system of claim 10 wherein the service information comprises information for the content source and currently broadcast content.

12. The system of claim 11 wherein the service information further comprises information for control channels of respective content.

13. A content distribution method for use between at least one content source comprising a service advertising channel and a content delivery channel, and at least one content sink, comprising:
providing service information on the service advertising channel, and providing content on the content delivery channel by the content source;
acquiring the service information from the service advertising channel by the content sink; and
specifying a content item from the content for playback according to the service information by the content sink.

14. The method of claim 13 further comprising controlling the content source via a control channel between the content source and the content sink by the content sink.

15. The method of claim 13 further comprising mixing a first content item and a second content item as the content, and providing the mixed content on the content delivery channel.

16. The method of claim 15 further comprising changing the first content item on the content source via a control channel between the content source and the content sink by the content sink.

17. The method of claim 16 further comprising providing the changed first content item on the content delivery channel by the content source.

18. The method of claim 17 further comprising receiving and playing back the changed first content item by the content sink specifying the first content item.

19. The method of claim 15 further comprising terminating the first content item on the content source via a control channel between the content source and the content sink by the content sink.

20. The method of claim 19 further comprising providing updated service information with the termination of the first content item on the service advertising channel by the content source.

21. The method of claim 20 further comprising stopping playback of the first content item by the content sink specifying the first content item.

22. The method of claim 13 further comprising broadcasting the content to the at least one content sink via a home network by the content source.

23. The method of claim 22 wherein the service information comprises information for the content source and currently broadcast content.

24. The method of claim 23 wherein the service information further comprises information for control channels of respective content.
